(19) United States
(12) Patent Application Publication
(10) Pub. No.: US 2022/0027487 A1
(43) Pub. Date: Jan. 27, 2022

(54) SYSTEM AND METHOD FOR SECURING AND MANAGING DATA IN STORAGE DEVICE BY USING SECURE TERMINAL

(71) Applicant: Citycat Co., Ltd., Seoul (KR)

(72) Inventors: Yangwoong Kim, Seoul (KR); Junga Woo, Seoul (KR); Riwon Kim, Seoul (KR)

(21) Appl. No.: 17/309,620

(22) PCT Filed: Sep. 9, 2019
(86) PCT No.: PCT/KR2019/011615

§ 371 Date: Jun. 10, 2021

(51) Int. Cl. G06F 21/62; G06F 21/35; G06F 21/60; G06F 21/78

(52) U.S. Cl. CPC G06F 21/6209; G06F 21/35; G06F 2221/2141; G06F 21/78; G06F 21/602

(57) ABSTRACT

The present invention relates to a system for securing and managing data in a storage device by using a secure terminal, wherein a storage area is divided into a normal area and a secure area, users are identified using the secure terminal, and only certified users are allowed access to the secure area. The present invention comprises a secure terminal and a storage device. In the present invention, only certified users access and control the secure area of the storage device, thus having the effect in which data can be protected.

### FIELD OF THE INVENTION

The present invention pertains to a data security management system for storage devices using secure terminals in which the storage area is divided into a general area and a secure area to identify users who use secure terminals, and in which access to the secure area is allowed only to those users who are certified.

### BACKGROUND OF THE INVENTION

A storage device is a device that can be carried by the user and with which to easily exchange and store data through computer interfaces. Representative interfaces include USB (Universal Serial Bus), Lightening, and Thunderbolt.

For convenience of use, a general storage device is configured so that computers with same ports are able to recognize data and to exchange and store data.

However, when a storage device is misplaced, it is possible for anyone who finds the storage device to check and extract data using a computer equipped with the same port, and the resulting damages are substantial.

To address this issue, an invention was developed (Republic of Korea Registered Patent No. 10-1385929) in which a fingerprint sensor is installed on a storage device to identify the user, and to allow only certified users to check and extract the data stored in the device.

However, in the case of the conventional technology, the cost increases due to the fact that the device's size increases with the installation of a sensor and due to the installation of a sensor. Additionally, due to physical force exerted, such as the location of the device for recognizing the fingerprint, pressure applied, and so on, the port becomes damaged.

### SUMMARY OF THE INVENTION

The present invention is about a data security management system for storage devices using a secure terminal in which the storage area is divided into a general area and a secure area, and in which access to the secure area is allowed only to authorized users. According to the present invention, only those users who are authorized to use the secure area of a storage device may access and control the data in the secure area, so that the present invention is effective in protecting data.

### BRIEF DESCRIPTION OF THE DRAWINGS

FIG. 1 is an illustrative drawing of an example of the data secure management system of a storage system using a secure terminal in accordance with the present invention.

FIG. 2 is a block diagram that illustrates the configuration of a secure terminal and a storage device in accordance with an embodiment of the present invention.

FIG. 3 is a flow diagram that illustrates an example of the data security management method of a storage device using the secure terminal in accordance with the present invention.

FIG. 4 is a flow diagram that illustrates the method of setting up access authorization of data security management of a storage device using the secure terminal in accordance with the present invention.

FIG. 5 is a flow diagram that illustrates another example of the data security management method of a storage device using the secure terminal in accordance with the present invention.

### DETAILED DESCRIPTION OF THE INVENTION

The present invention was developed in order to resolve the conventional problems described above. The present invention provides a small computer equipped with an identification function through a biological recognition sensor to identify the user based on the user's voice, face, fingerprint, or iris, a user identification function that requires a password or uses pattern recognitions, and a function for the user to transmit control signals through near-field wireless communication, and a method to control the storage device that is controlled by receiving the control signals generated by the aforementioned certified user, and that protects data at each step by sensing abnormal approaches such as control signals of uncertified users.

Additionally, the present invention provides a control method whereby all or part of the storage component of a storage device is set or unset as secure area, whereby stored data is modified, and whereby access to the secure area is allowed or disallowed.

Additionally, the present invention provides a method of encoding and storing the data in the aforementioned secure area, and a method to decode data when checking and extracting data.

According to the characteristics of the present invention to achieve the aforementioned purpose, the present invention is composed of a secure terminal that includes a user authorization module that generates the user identification information by identifying the user, a controller that transmits the secure access information that corresponds to the aforementioned user identification information to the storage device, a storage module in which the secure access information corresponding to the aforementioned user identification information is stored, and a near-field communication module that transmits and receives the aforementioned secure access information through near-field communications, an interface component that connects with computers to enter and extract data, a near-field wireless communication component that transmits to and receives from the aforementioned secure terminal secure access information, and a memory that stores data, a storage component divided into the general area and the secure area, and a controller that receives secure access information from the aforementioned secure terminal to determine whether to selectively activate the secure area according to the user authorization results.

Here, the aforementioned secure access information could be a one-time password that is different each time a password is generated.

Additionally, the aforementioned controller could transmit previously stored secure access information and newly generated secure access information to the storage device, and if the aforementioned storage device's secure area is activated, the aforementioned already-stored secure access information could be renewed as newly generated secure access information.

Additionally, the aforementioned storage device could further include an encoding key generation module that encodes the secure access information received from the aforementioned secure terminal through the aforementioned user identification information, through the aforementioned secure terminal's unique information terminal identification information, or through the storage device's unique information.

Additionally, the aforementioned controller could compare the data encode key generated from the secure access information received from the aforementioned secure terminal and stored with the data encoding key stored in the storage device, in order to determine whether to activate the secure area, and in the event that the aforementioned secure area is activated, the data encoding key stored in the aforementioned storage device could be renewed with the data encoding key generated from the newly generated secure access information received from the aforementioned secure terminal and stored.

Additionally, the aforementioned secure access information could be a one-time password that is generated differently each time, the aforementioned user identification number, terminal identification number, which is the aforementioned secure terminal's unique information, or data encoding key generated through the storage device's unique information.

Additionally, the aforementioned controller could transmit the already stored secure access information and newly generated secure access information to the storage device, and could renew the aforementioned already stored secure access information as newly generated secure access information if the secure area becomes activated.

Additionally, the aforementioned controlling component could determine whether to activate the secure area by comparing the already-stored secure access information received from the aforementioned secure terminal with the data encoding key stored in the above storage device, and if the aforementioned secure area is activated, the data encoding key stored in the above storage device could be renewed and stored as newly generated secure access information received from the aforementioned secure terminal.

Additionally, the aforementioned controller could encode and store the data stored in the aforementioned secure area through the aforementioned data encoding key, and could decode and read the data stored in the aforementioned secure area through the aforementioned data encoding key.

Additionally, the aforementioned secure access information could be file system information that defines data storage, search, and access systems for the aforementioned secure area.

Additionally, the aforementioned controller could transmit the aforementioned file system information renewed when the aforementioned file system is renewed to the aforementioned secure terminal.

Additionally, the aforementioned controller could delete the aforementioned file system information if access to the secure terminal through the aforementioned near-field wireless communication component becomes cancelled.

Additionally, if data that sets access authorization is stored in the aforementioned secure area, the aforementioned controller generates file system information for the aforementioned data that sets access authorization, to be included and stored in the file system information for the aforementioned general area.

Additionally, the file system information for the data that sets access authorization could include setup information for access authorization, and the aforementioned access authorization could be about permitting data reading, copying, modification, deletion, or printing.

Additionally, the aforementioned controller and controlling component could maintain communications of the secure terminal and the storage device through communication data encoded using a communication encoding key, wherein the aforementioned communication encoding key is a unique value generated by combining at least two of the aforementioned user identification information, the terminal identification number, which is the aforementioned secure terminal's unique information, the aforementioned storage device's unique information, or a randomly generated value when the aforementioned secure terminal and the storage device are registered, and could be stored in the aforementioned secure terminal and in the aforementioned storage device.

Additionally, the aforementioned controlling component could set up or reset the size of the aforementioned secure area and the size of the general area depending on the control signals of the aforementioned secure terminal.

Additionally, the aforementioned user authorization module could be composed of a biological recognition module that identifies the user's fingerprint or iris.

Additionally, the aforementioned user authorization module could be composed of a key pad module that receives an authorization number or authorization pattern from the user.

Additionally, while authorization for the aforementioned secure access information has not been approved, the aforementioned controlling component could permanently delete the data stored in the aforementioned secure area if data access to the aforementioned secure area through the aforementioned interface component is recognized.

On the other hand, the present invention includes a data security management method of a storage device using a secure terminal that includes (A) the step in which the user identification information is generated by identifying the user through the secure terminal, (B) the step in which the aforementioned secure terminal is connected to the storage device through near-field wireless communication, (C) the step in which the aforementioned secure terminal transmits to the aforementioned storage device secure access information that corresponds to the aforementioned user identification information, and (D) the step in which the aforementioned secure access information received by the aforementioned storage device is used in order to certify the user, and the secure area included in the aforementioned storage device is activated, in order to allow access to the data stored in the aforementioned secure area.

Here, the aforementioned secure access information could be a one-time password generated differently each time, and the aforementioned secure access information in step (C) could include secure access information already stored in the aforementioned secure terminal and newly generated secure access information.

Additionally, the aforementioned step (D) could further include the step in which the aforementioned already stored secure access information is renewed as newly generated secure access information, in the event that the aforementioned secure terminal activates the aforementioned storage device's secure area.

Additionally, the aforementioned storage device could further include an encoding key generation module to encode the secure access information received from the aforementioned secure terminal through the aforementioned user identification information, the aforementioned secure terminal's unique information terminal identification information, or through the storage device's unique information.

Additionally, user authorization in the aforementioned step (D) could include the step in which the data encoding key generated from the already stored secure access information received from the aforementioned secure terminal and the data encoding key stored in the storage device, in order to determine whether to activate the secure area, and the step in which if the secure area is activated, the data encoding key stored in the aforementioned storage device is renewed and stored as data encoding key generated from the newly generated secure access information received from the aforementioned secure terminal.

Additionally, the aforementioned secure access information could be a one-time password generated differently each time, the aforementioned user identification information, the aforementioned secure terminal's unique information terminal identification information, or a data encoding key generated through the storage device's unique information.

Additionally, the secure access information in step (C) above could include secure access information already stored in the aforementioned secure terminal and newly generated secure access information.

Additionally, the aforementioned step (D) could further include the step in which the aforementioned already stored secure access information is renewed as newly generated secure access information, if the aforementioned storage device's secure area is activated.

Additionally, the user authorization in step (D) above could include the step in which the already-stored secure access information received from the aforementioned secure terminal is compared with the data encoding key stored in the aforementioned storage device, in order to determine whether to activate the secure area, and the step in which the data encoding key stored in the aforementioned storage device is renewed and stored as newly generated secure access information, if the aforementioned secure area becomes activated.

Additionally, the aforementioned controlling component could encode and store the data stored in the aforementioned secure area through the aforementioned data encoding key, and could decode and read the data stored in the aforementioned secure area through the aforementioned data encoding key.

Additionally, the aforementioned secure access information is file system information that defines data storage for the aforementioned secure area, and that defines search and access system, and could further include (E) the step in which, if the aforementioned secure access information is changed by the use of the aforementioned secure area, the aforementioned changed secure access information is transmitted by the aforementioned storage device to the aforementioned secure terminal, and (F) the step in which if connection of the aforementioned storage device and the aforementioned secure terminal is cancelled, the secure access information stored in the aforementioned storage device is deleted.

Additionally, the aforementioned controlling component could generate file system information for the data for which the aforementioned access authorization is set up if the data that sets up access authorization is stored in the aforementioned secure area, to be included in the file system information for the aforementioned general area.

Additionally, the file system information for the data that sets up access authorization could include setup information for access authorization, and the aforementioned access authorization could be regarding whether to approve reading, copying, modification, deletion, or printing of data.

Additionally, user identification in step (A) above could be carried out by identifying the user's fingerprint or iris.

Additionally, user identification in step (A) above could be carried out by receiving from the user the authorization number or authorization pattern.

The following effects could be expected from the data secure management system and method for storage devices using a secure terminal under the present invention.

Namely, under the present invention it is possible to protect data by allowing only certified users to access the secure area of a storage device.

Additionally, the storage device size could be substantially reduced compared to the conventional technology in which a fingerprint sensor or keypad is installed on a storage device.

Additionally, with the interface that is standardized with storage devices, it is not necessary to install a separate program for authorization purposes depending on the operating system of the computer that exchanges data. Namely, under the present invention, it is possible to render a secure system for a storage device without installing a separate program on a PC, so that a portable secure storage device can be used with all PC's, thereby improving user convenience.

The data secure management system of a storage device using the secure terminal in accordance with an advisable embodiment of the present invention is composed of a secure terminal that includes a user authorization module that generates the user identification information by identifying the user, a controller that transmits the secure access information that corresponds to the aforementioned user identification information to the storage device, a storage module in which the secure access information corresponding to the aforementioned user identification information is stored, and a near-field communication module that transmits and receives the aforementioned secure access information through near-field communications, an interface component that connects with computers to enter and extract data, a near-field wireless communication component that transmits to and receives from the aforementioned secure terminal secure access information, and a memory that stores data, a storage component divided into the general area and the secure area, and a controller that receives secure access information from the aforementioned secure terminal to determine whether to selectively activate the secure area according to the user authorization results.

Here, the aforementioned secure access information is authorization information to activate the secure area of a storage device, and the aforementioned secure access information could be a one-time pass that is generated differently each time, could be a data encoding key generated through unique information such as the aforementioned one-time password, the aforementioned user identification information, the aforementioned secure terminal's unique information terminal identification information, the storage device's unique information, and so on, and could be file system information that defines data storage, search, and access systems for the aforementioned secure area.

Below, the data security management system and method of a storage device using the secure terminal in accordance with detailed embodiments of the present invention will be examined by referring to the attached drawings.

Before explaining, the effects and characteristics of the present invention, as well as the method of achieving these will become clear with the attached drawings and with the embodiments that will be described in detail later. However, the present invention is not limited by the embodiments to be presented below, but could be rendered in many different forms. These embodiments are presented in order to fully present the present invention, and in order to fully inform those with ordinary level of knowledge in the technological field in which the present invention belongs about the scope of the present invention, and the present invention is defined only by the scope of the claims.

In describing the embodiments of the present invention, if it is determined that detailed descriptions of the notification functions or configurations could unnecessarily blur the gist of the present invention, such detailed descriptions will be omitted. The terms to be defined later are terms that were defined in consideration of the functions of the embodiments of the present invention, and could change depending on the intentions or conventions of the user or operator. Therefore, the definitions must be determined based on the overall content of this statement.

Each block of the attached block diagrams and the combinations of each step in the flow diagrams could be carried out by computer program instructions (execution engines), and these computer program instructions could be installed on a general computer, a special computer, or any programmable data processing device processor, so the instructions that are carried out through any programmable data processing device's processor generates a method of carrying out the functions described in block or in each step of a flow diagram.

Since these computer program instructions could be stored in a memory capable of using computers or capable of reading computers and that is compatible with computers or other programmable data processing devices in order to render functions in specific ways, the instructions stored in a memory that can use computers or that can read computers could produce production items that contain instruction methods that perform the functions described in each block or in each step of a flow diagram.

Additionally, since the computer program instructions could be installed on a computer or on any programmable data processing device, the instructions that operate a computer or any programmable data processing device by generating processes that are performed with a compute when a series of operating steps is performed on the computer or programmable data processing device could provide steps to perform the functions that are described in each block of a block diagram or in each step of the flow diagram.

Additionally, each block or each step could exhibit part of a module, segment, or code containing one or more executable instructions to execute specific logical functions, and in several alternative embodiments it is possible for the functions mentioned in blocks or steps could deviate from the original order.

Namely, the illustrated two blocks or steps could be performed simultaneously, and it is possible for these blocks or steps to perform functions in the opposite order as needed.

Below, the case in which the aforementioned secure access information is file system information will be explained, and then the case in which the aforementioned secure access information is a one-time password or a data encoding key will be explained.

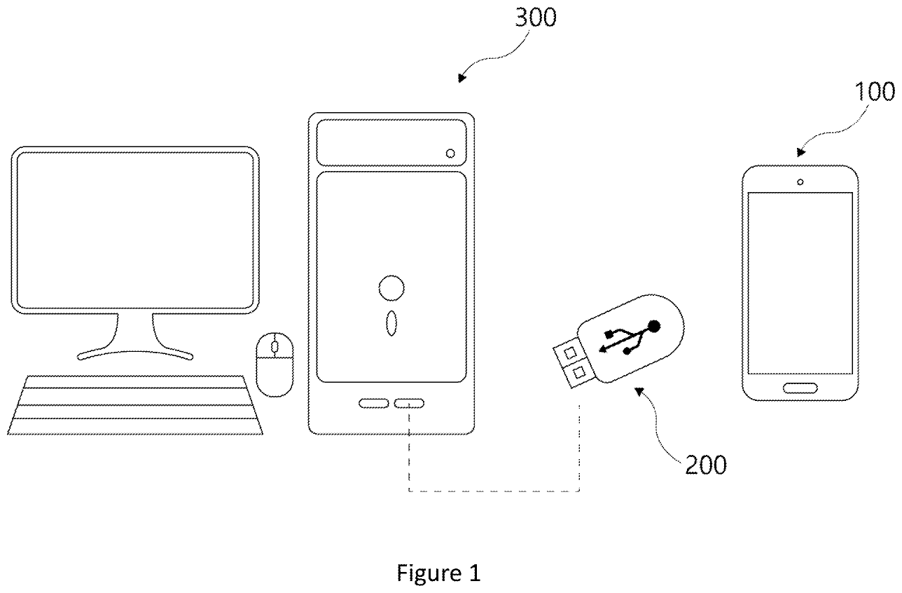

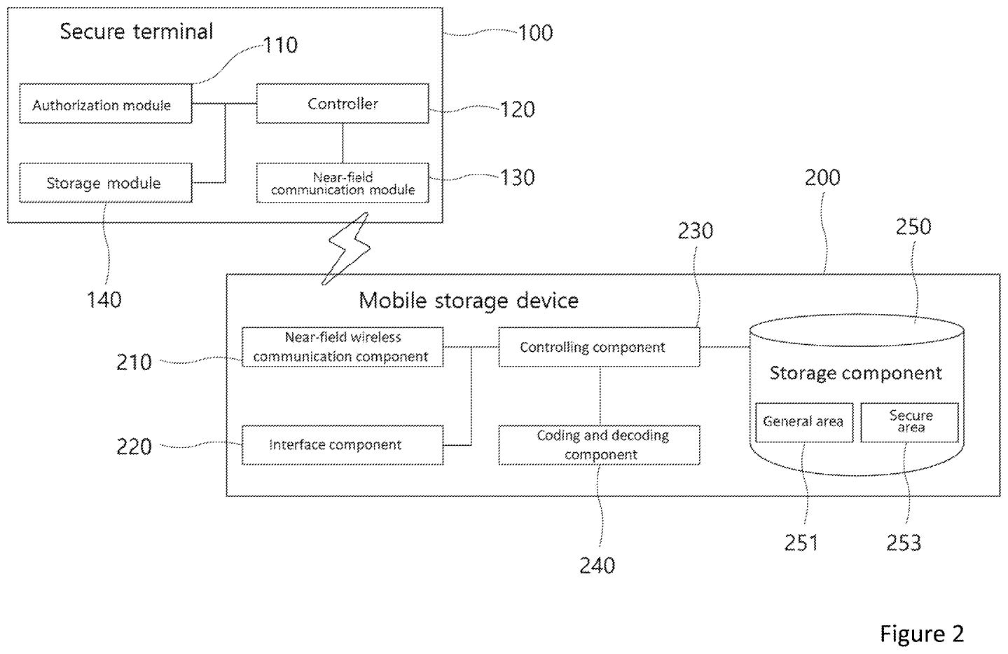

Referring to FIGS. 1 and 2, the aforementioned storage module 140 is the storage space where the secure terminal 100 is installed, and data to operate the aforementioned secure terminal 100, as well as the aforementioned file system information related to the present invention, is stored there.

Additionally, the aforementioned near-field communication module 130 is connected to the aforementioned storage device 200, and transmits the aforementioned file system information to the aforementioned storage device 200 through near-field communication.

Here, the aforementioned near-field communication module could be configured in an NFC (near-field communication module) or Bluetooth module.

On the other hand, the aforementioned storage device 200 is described in this statement based on a USB device, which is a portable storage medium, but the storage device could be an external hard disk, an internal hard disk, or any other storage device.

Here, the storage device 200 in accordance with the present invention is composed of a near-field wireless communication component 210, an interface component 220, a controlling component 230, and encoding and decoding component 240, and a storage component 250.

The aforementioned near-field wireless communication component 210 connects with the aforementioned secure terminal 100 near-field communication module 130 to transmit and receive the aforementioned file system information.

Additionally, the aforementioned interface component 220 refers to a regular connection terminal for the aforementioned storage device 200 to connect with a PC.

The aforementioned storage component 250 is the data storage space for the aforementioned storage device 200, and the storage area is divided into the general area 251 and the secure area 253.

The aforementioned general area 251 refers to the storage space where it is possible to use without any separate authorization process, such as the conventional USB storage space, and the aforementioned secure area 253 refers to the storage space that can be used only when the user is certified through the aforementioned secure terminal 100.

For this purpose, under the present invention the system file to operate the aforementioned general area 251 and the system file to operate the aforementioned secure area 253 are divided.

Of course, in the case of other embodiments of the present invention, it is possible to integrate the aforementioned general are and secure area so that these two areas would be indistinguishable.

In the case of this embodiment, the system file to operate the aforementioned secure area 253 is referred to as file system information.

Namely, under the present invention the file system information refers to the information that defines data storage, search, and access systems for the aforementioned secure area 253, and the aforementioned access system includes the physical location and size of the secure area 253.

On the other hand, the aforementioned controlling component 230 receives file system information from the aforementioned secure terminal 100 to activate the aforementioned secure area 253.

Additionally, in using the aforementioned secure area 253, the aforementioned controlling component 230 immediately transmits changed file system information to the aforementioned secure terminal 100 in the event that the aforementioned file system information changes due to the occurrence of any changes in the stored data.

As a result, it is possible for the aforementioned secure terminal 100 to store in real time the changed file system information related to the aforementioned secure area 253.

Additionally, diverse functions of the aforementioned controlling component 230 will be described in detail later.

Additionally, the aforementioned encoding and decoding component 240 encodes and stores the data stored in the aforementioned secure area 253 through a data encoding key, and decodes the data stored in the aforementioned secure area 253 through the aforementioned data encoding key, and the purpose is to maintain security even in the event that the data in the aforementioned secure area 253 is taken out abnormally with an unauthorized device.

Generation and configuration of the aforementioned data encoding key will be described in detail later.

As described above, the aforementioned controlling component 230 could be used by a user who is authorized to use the aforementioned storage component's secure area.

There could be many different technical configurations for this, but in the case of this embodiment, the system file information to operate the aforementioned secure area 253 is received from a secure terminal 100.

Here, the aforementioned controlling component 230 deletes the aforementioned system file information if connection to the aforementioned secure terminal 100 is cancelled, and it is possible to configure the system so that while the aforementioned secure terminal 100 is not connected the aforementioned secure area 253 cannot be used.

Additionally, unlike above, a volatile memory (not illustrated) could be added to store the aforementioned system file information in the aforementioned storage device 200, and it is possible to store and use in the aforementioned volatile memory the aforementioned system file information received from the aforementioned secure terminal 100.

In this case, while the aforementioned storage device 200 is connected to a PC and power is provided, when the aforementioned system file information is received from the secure terminal 100 to store the aforementioned system file information in the aforementioned volatile memory, until the aforementioned storage device 200 is separated from the PC the aforementioned secure area 253 can be used even if connection to the aforementioned secure terminal 100 is not maintained.

On the other hand, the data stored in the aforementioned secure area 253 could be encoded by the data encoding key shared by the aforementioned secure terminal 100 and storage device 200, and the aforementioned data encoding key could be generated by the aforementioned secure terminal 100 controller 120.

Specifically, the aforementioned data encoding key could be generated by including one or more of the identification information for identified users, the aforementioned secure terminal 100 unique information terminal identification information, and the storage device 100 unique information.

In the case of another embodiment of the present invention to be described later, a data encoding key is generated by including user identification information, terminal identification information, or storage device's unique information in the randomly generated one-time password extracted, and user authorization can be performed through the aforementioned process, and this will be explained later.

Namely, the aforementioned controller 120 can receive the storage device's unique information from the aforementioned storage device 200, generate a data encoding key using the identification information of the recognized user and using the terminal identification information, and provide the aforementioned data encoding key generated to the storage device 200.

Additionally, the aforementioned data encoding key could be generated and shared as one-off item, and in this case it is possible to include in the aforementioned data encoding key a random key that is generated as one-off item.

On the other hand, the aforementioned controlling component 230 and the controller 120 could encode and transmit communication data that contains control signals, and could generate a communication encoding key to decode the received communication data, to be kept by each.

The aforementioned communication encoding key could be generated when a storage device is registered in the aforementioned secure terminal, and could be stored in the aforementioned secure terminal and the aforementioned storage device.

Here, the aforementioned communication encoding key could be generated by combining at least two of the aforementioned user identification information, the aforementioned secure terminal's unique information terminal identification information, the aforementioned storage device's unique information, and a randomly generated value.

On the other hand, the aforementioned control signals could be control signals to perform various functions. For example, the control signals could set up or reset the size of the general area 251 and the size of the secure area 253 of the aforementioned storage component 250.

Namely, the aforementioned controlling component 230 could receive encoded control signals from the aforementioned controller 120 by using the aforementioned data encoding key, and set up or reset the size of the aforementioned secure area 253 and the size of the general area 251.

On the other hand, the size of the aforementioned general area 251 and the size of the aforementioned secure area 253 could be automatically adjusted by the aforementioned controlling component 230.

As a specific example of this, the aforementioned controlling component 230 could reset the size of the aforementioned secure area 253 and the size of the aforementioned general area 251 in order to maintain the ratio of the unused remaining space of the aforementioned secure area 253 and the unused remaining space of the aforementioned general area.

In this case, even when the storage space with limited size is divided into the general area and secure area, the ratio of the remaining spaces of both areas is maintained consistently, so that it is possible to use all spaces without having to separately set up the entire storage space even if one area is used more than the other area.

Additionally, in the event that access by an unauthorized user to the secure area 253 is recognized, the aforementioned controlling component 230 could permanently delete the data stored in the aforementioned secure area 253. Here, it is possible to determine authorization based on authorization of the aforementioned data encoding key.

Additionally, the user may set up access authorization for some of the files stored in the secure area 253, in order for unauthorized users that have access authorization may access the applicable files.

To examine in detail the method applied to the present invention, in the event that data for which access authorization has been set up is stored in the aforementioned secure area 253, the aforementioned controlling component 230 generates file system information for the data for which the aforementioned access authorization has been set up, and then includes the aforementioned file system information in the file system information for the aforementioned general area 251.

As a result, in the event that an unauthorized user tries to use the storage device 200 under the present invention, use of only the general area is allowed. Since the file system for the data for which access authorization has been set up is stored in the file system for the aforementioned general area 251, it is possible for the user to access the files stored in the aforementioned secure area 253 according to the access authorization set up.

Here, the aforementioned access authorization could set up authorization for part or all of reading, copying, modifying, deleting, and printing data.

Next, a one-time password (random key value) that is generated differently when the secure access information under the present invention is generated will be explained.

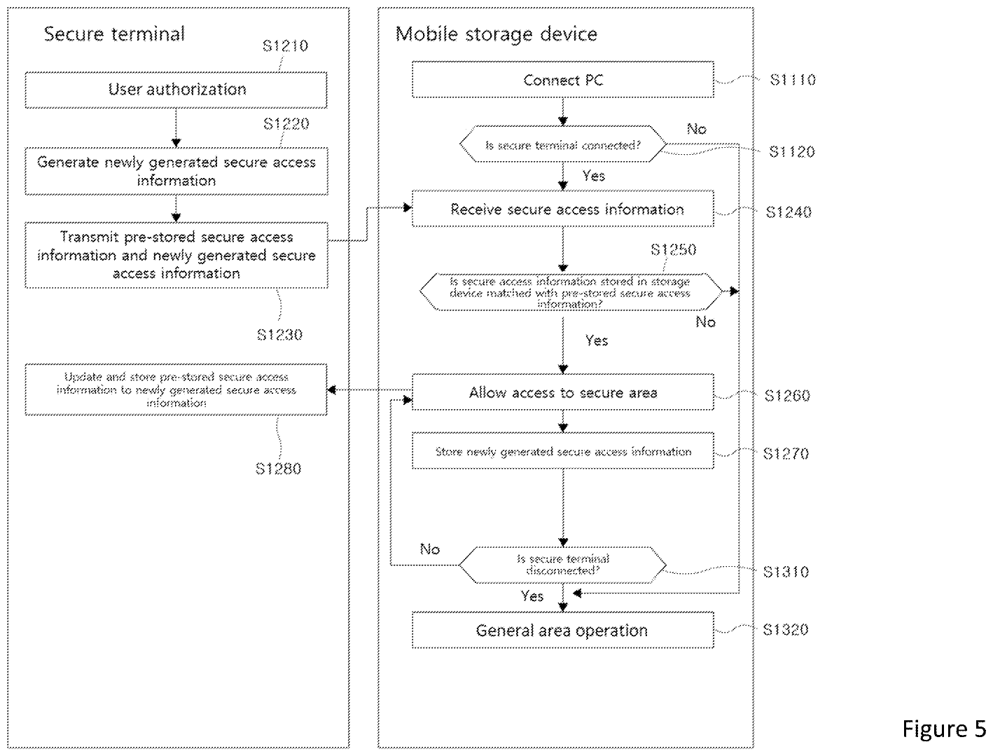

In the case of this embodiment, as illustrated in FIG. 5, the aforementioned controller transmits already stored secure access information and newly generated secure access information to the aforementioned storage device when connecting to the storage device.

Here, the aforementioned already-stored secure access information refers to the secure access information (one-time password) generated as one-off item when connecting to the aforementioned storage device for the last time, and newly generated secure access information refers to newly generated secure access information (one-time password).

Afterwards, the aforementioned storage device that received the aforementioned already-stored secure access information and newly generated secure access information carries out authorization for the secure terminal by comparing the received already-stored secure access information and the secure access information stored in the storage device, and allows access authorization to the secure area.

Here, if the secure area of the aforementioned storage device becomes activated, namely if authorization is successful, the aforementioned storage device renews the stored secure access information as newly generated secure access information received from the aforementioned secure terminal, and prepares for the next authorization for the secure access information that is generated as one-time item.

Of course, in the event that the secure area of the aforementioned storage device is activated, the aforementioned secure terminal renews and stores the aforementioned already-stored secure access information as newly generated secure access information.

Next, supplementary functions of the secure terminal and the storage device under the present invention will be described.

First, the aforementioned secure terminal could control the usage state of the storage device through the MDM (mobile device management) through a server.

Namely, a user authorized by an external server could access the aforementioned secure terminal, and transmit remote control commands.

Here, in the event that remote control commands are received from an external server, the aforementioned controller deletes data for the aforementioned secure area of the aforementioned storage device, restricts access, restricts authorization, extracts login information, and so on according to the aforementioned remote control commands.

Next, the aforementioned storage device could restrict access to the secure area according to the access distance from the aforementioned secure terminal.

Namely, the aforementioned storage device's controlling component could restrict access to the secure area in the event that cancellation of the connection with the secure terminal is recognized through the aforementioned near-field communication module.

Accordingly, even after the secure area of the aforementioned storage device is activated through the aforementioned secure terminal, if the aforementioned secure terminal is deviated, it is possible to immediately prohibit use of the aforementioned secure area.

In this case, the situation in which connection with the aforementioned secure terminal has been cancelled was explained, but this could be applied even in the case in which connection has not been cancelled, but the distance has deviated from a certain range.

On the other hand, in the event that authorization errors are repeated the aforementioned storage device could restrict authorization for certain period of time or permanently.

Namely, the aforementioned controlling component could store the number of authorization failures through the aforementioned secure terminal, and could restrict authorization for the aforementioned secure area in the event that the aforementioned number of failures exceeds the value set up in advance.

Below, a specific embodiment of the method of data security management of a storage device using the secure terminal under the present invention will be described in detail by referring to the attached drawings.

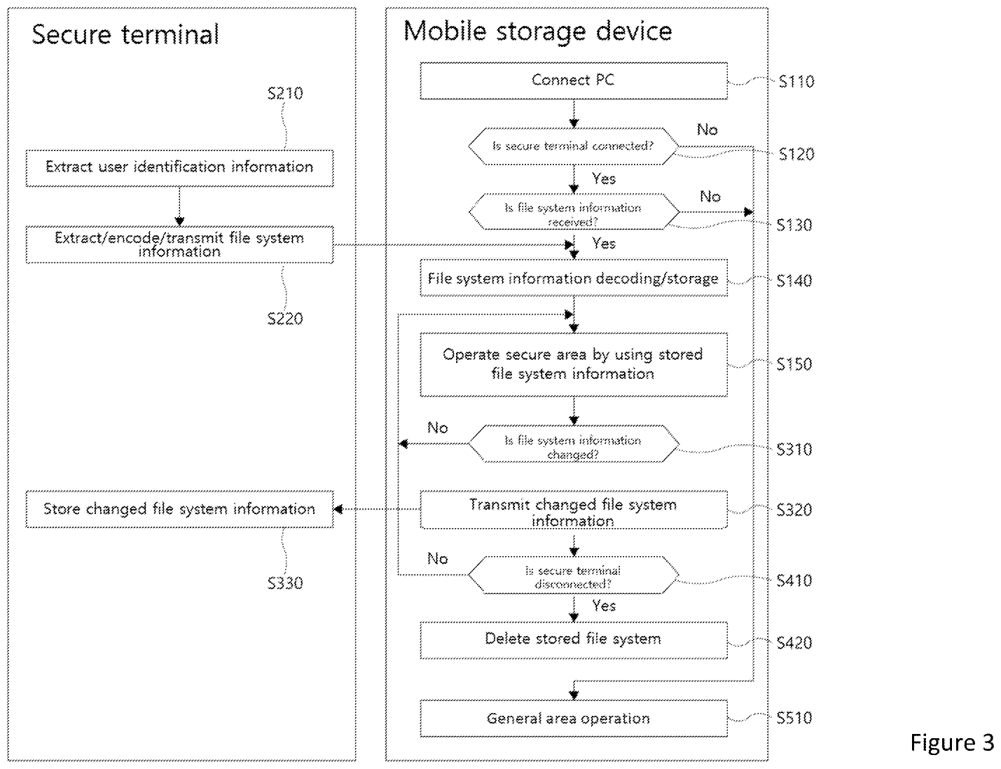

As illustrated in FIG. 3, the method of data security management for a storage device using the security terminal under the present invention starts when a storage device 200 is connected to a PC step S110.

Afterwards, the aforementioned storage device 200 determines whether the secure terminal 100 has been connected through near-field communication, and whether file system information has been received from the aforementioned secure terminal 100 through the aforementioned near-field communication steps S120, S130.

On the other hand, the aforementioned secure terminal 100 identifies the user through the authorization module 110 separate from step S110 to step S130, and extracts user identification information from the identified user step S210.

At this time, the aforementioned authorization module 100 could apply various authorization methods, and advisable a biological recognition method based on iris recognition, fingerprint recognition, facial recognition, finger vein identification, voice recognition, and so on could be applied.

Additionally, file system information applicable to the aforementioned user's identification information is extracted and encoded with a data encoding key, and then the encoded file system information is transmitted to the storage device 200, step S220.

Of course, in the event that there is only one user for the aforementioned secure terminal 100 at step S220, the file system information of the aforementioned step S220 is composed of a single item.

Additionally, since generation and sharing of the aforementioned data encoding key was described previously, detailed explanation will be omitted here.

On the other hand, under the present invention, in the event that authorization is granted by multiple secure terminals, the system could be set up so that the aforementioned file system information could be transmitted or activated.

In this case, the aforementioned storage device could be configured so that the aforementioned file system information is received only when the data encoding key is transmitted by multiple secure terminals set up in advance through near-field wireless communication.

Additionally, the aforementioned file system information could be encoded and transmitted by a data encoding key configured by including multiple authorization values that correspond to multiple secure terminals set up in advance. Here, it is possible to set up the system so that the aforementioned storage device receives all authorization values from the aforementioned multiple secure terminals, and to activate the aforementioned file system only through the data encoding key generated from these.

On the other hand, in accordance with step S220 above, in the event that the aforementioned file system information is received after the secure terminal 100 is accessed in the aforementioned step S120 and step S130, the received file system information is decoded through the encoding and decoding component by using the data encoding key and then stored step S140.

Here, the aforementioned file system information could be stored in the aforementioned storage component 250 in accordance with the embodiment, or could be stored in a separate volatile memory.

After the aforementioned file system information received is stored, the secure area 253 of the aforementioned storage component 250 is operated using the stored file system information.

Of course, in the event that the secure terminal 100 is not connected, or the aforementioned file system information is not received in the aforementioned step S120 and step S130, since there is no file system information for the aforementioned secure area 253 the aforementioned secure area 253 is not recognized, and only the general area 251 is recognized/operated using the file system for the general area step S510.

On the other hand, while operating the secure area based on the aforementioned step S150, in the even that any changes to the aforementioned file system information occur, the aforementioned controlling component 230 transmits the changed file system information to the secure terminal 100, steps S310, S320.

Additionally, the secure terminal 100 stores the aforementioned changed file system information step S330.

Next, the aforementioned controlling component 230 recognizes cancellation of connection to the aforementioned secure terminal 100, so when connection to the aforementioned secure terminal 100 is cancelled, the stored file system information is deleted steps S410, S420.

Accordingly, the aforementioned secure terminal 100 is reconnected, so it is not possible to use the aforementioned secure area 253 until the aforementioned file system information is received again.

Of course, in the event that the aforementioned file system information is stored in a volatile memory, if the aforementioned storage device 200 is separated from the PC, the aforementioned file system information is deleted automatically.

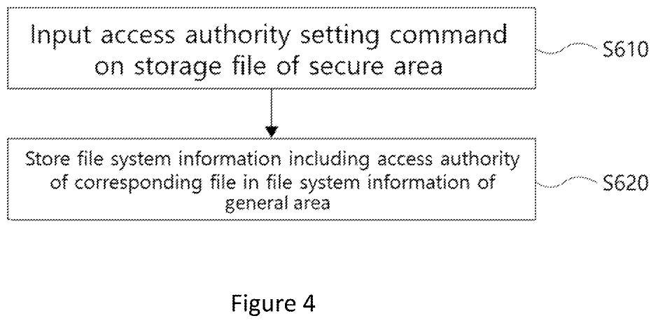

Below, the case in which access authorization is set up regarding storing of files in the secure area by a user will be described by referring to FIG. 4.

As illustrated in FIG. 4, when the user provides access authorization or sets up access authorization for already-stored files while storing files in the secure area 253, the aforementioned controlling component 230 recognizes input commands for the access authorization setup step S610.

Afterwards, the aforementioned controlling component 230 includes the file system for the applicable files in the file system information for the general area step S620. At this time, access authorization is included in the aforementioned applicable file system.

As a result, the user provides partial authorization to the files, so that unauthorized users may access some of the files stored in the aforementioned secure area 253.

On the other hand, the method of resetting the size of the general area 251 and the size of the secure area 253 of the aforementioned storage component 230, the method of generating data encoding keys, the method of encoding and decoding data and control signals using data encoding keys, and the method of deleting data when the secure area is accessed by an unauthorized user were described previously, so detailed descriptions will be omitted.

Additionally, under the present invention user authorization could take place by confirming the aforementioned data encoding key.

Next, the method of authorization using a one-time password (random key value) that is generated differently each time the secure access information is generated in accordance with the present invention will be described by referring to FIG. 5.

In the case of this embodiment, the process in which the storage device 200 is connected with a PC step S1110, the process in which connection to the secure terminal 100 is confirmed step S1120, and the user authorization process through the authorization module 110 step S1210 are identical to the embodiments described previously, so detailed descriptions will be omitted.

On the other hand, the aforementioned secure terminal generates new secure access information, and then reads already-stored secure access information stored with the newly generated secure access information, and then sends this information to the storage device steps S1220, S1230.

Here, the aforementioned already-stored secure access information refers to the secure access information generated as one-time item and stored when connected for the last time with the aforementioned storage device (one-time password), and the newly generated secure access information refers to newly generated secure access information (one-time password).

In this case, the aforementioned secure access information could be the one-time password (random key value) itself, or could be encoded data generated by encoding the aforementioned one-time password and including the user identification information, the aforementioned secure terminal's unique information terminal identification information, and the storage device's unique information.

Afterwards, the storage device that receives the aforementioned already-stored secure access information and newly generated secure access information step S1240 determines whether the received already-stored secure access information the secure access information stored in the storage device step S1250.

Based on the result of step S1250 above, in the event that both sets of secure access information match, the user is authorized, and access to the secure area is allowed step S1260.

In the event that the aforementioned storage area's secure area is activated as a result, namely if authorization is successful, the aforementioned storage device renews and stores the stored secure access information as newly generated secure access information received from the aforementioned secure terminal, in order to prepare for the next authorization for the secure access information that is generated as one-off item step S1270, and the aforementioned secure terminal renews and saves the aforementioned already-stored secure access information as newly generated secure access information step S1280.

Of course, even in this case, if connection of the aforementioned secure terminal is cancelled step S1310, or in the event that based on the result of step S1120 it is determined that there is no connection with the secure terminal, or in the event that based on the result of step S1250 it is determined that user authorization has not been granted, the aforementioned storage device's secure area remains inactive, and only the general area is operated step S1320.

The rights related to the present invention are not limited to the embodiments described above, and are defined by the scope of claims, and it is clear that it is possible for those with ordinary level of knowledge in the field in which the present invention belongs to make various modifications and changes without deviating from the scope of rights indicated in the scope of claims.

1. A user authentication module system for identifying a user and generating user identification information comprising;
a controller for transmitting secure access information corresponding to the user identification information to a storage device;
a storage module for storing security access information corresponding to the user identification information;
a security terminal comprising a short-distance communication module for transmitting and receiving the secure access information through short-range communication, and an interface unit for connecting to a computer to enable data input and output;
a short-range wireless communication unit for transmitting and receiving secure access information with the secure terminal;
a storage unit comprising a memory for storing data, the storage unit being divided into a general area and a security area; and,
a storage device configured to receive the secure access information from the secure terminal, and to determine whether to selectively activate the secure area according to a user authentication result.

2. The system of claim 1, wherein the secure access information is a one-time password that is generated with a different value each time it is generated.

3. The system of claim 1, wherein the security access information is generated by adding one or more of the user identification information, the terminal identification information of the security terminal, and unique information of the storage device.

4. The system of claim 1, wherein the controller transmits the stored security access information and new generation security access information to the storage device; and,
when the security area of the storage device is activated, the controller updates the stored security access information as the new generation security access information.

5. The system of claim 4, wherein a control unit determines whether the security area is activated by comparing the stored security access information received from the security terminal with the security access information stored in the storage device, and updates the security access information stored in the storage device with new generation security access information received from the security terminal when the security area is activated.

6. The system of claim 5, wherein the storage device further comprises:
an encryption key generation module for encrypting the security access information received from the security terminal through the user identification information,
the terminal identification information, which is one of unique information of the security terminal, and unique information of the storage device, and,
generating a data encryption key.

7. The system of claim 6, wherein a control unit encrypts and stores the data stored in the security area through the data encryption key, and decodes the data stored in the security area through the data encryption key and reads the data.

8. The system of claim 1, wherein the security access information is file system information defining a data storage, a search, and an access scheme for the security area.

9. The system of claim 8, wherein the controller transmits updated file system information to the security terminal when a file system is updated.

10. The system of claim 9, wherein the control unit deletes the file system information when a connection with the security terminal through a local area wireless communication unit is released.

11. The system of claim 10, wherein the control unit generates file system information for the data to which access authority is set, and stores the file system information in the file system information for the general area when the access authority is stored in the security area.

12. The system of claim 11, wherein the file system information for the data to which the access authority is set includes setting information about the access authority, and the access authority is an allowance for reading, copying, changing, deleting, or outputting data.

13. The system of claim 1, wherein:
the controller and a control unit maintain communication of the security terminal and the storage device through encrypted communication data using a communication encryption key; and,
wherein the communication encryption key is stored in the security terminal and the storage device with a unique value generated by a combination of two or more of the user identification information, terminal identification information which is unique information of the security terminal, unique information of the storage device, and a random generation value when registering between the security terminal and the storage device.

14. The system of claim 13, wherein a control unit sets and resets the security area and the general area according to a control signal of the security terminal.

15. The system of claim 14, further comprising:
a biometric recognition module for identifying a user's fingerprint or iris.

16. The system of claim 14, further comprising:
a keypad module for receiving an authentication number or an authentication pattern from a user.

17. The system of claim 14, wherein the control unit permanently deletes the data stored in the security area when data access to the security area is detected through the interface unit in a state in which authentication by the security access information is not allowed.

18. The system of claim 14, wherein, when a remote control command is received from an external server, the controller performs one of data deletion, access restriction, authentication restriction, and log information extraction for the security area of the storage device according to the remote control command.

19. The system of claim 14, wherein the control unit restricts access to the security area when a connection release with the security terminal through the local area communication module is detected.

20. The system of claim 14, wherein the control unit accumulates and stores a number of failures of authentication through the security terminal, and limits authentication for the security area when number of failures exceeds a predetermined value.

21. A method for managing a data security of a storage device using a security terminal, the method comprising the steps of:
(a) generating user identification information by being identified by a user through a security terminal;
(b) allowing the security terminal to be connected to a storage device through short-range wireless communication; and
(c) allowing the security terminal to authenticate a user by using security access information received by the storage device, and to activate a security area included in the storage device to access data stored in the security area.

22. The method of claim 21, wherein the security access information is a one-time password generated with different values for each generation time.

23. The method of claim 21, wherein the security access information is generated by adding one or more of the user identification information, the terminal identification information of the security terminal, or unique information of the storage device to a one-time password generated with different values for each generation time.

24. The method of claim 22, wherein the security access information of step (c) includes stored security access information stored in the security terminal and newly generated new generation security access information.

25. The method of claim 24, further comprising the step of updating the stored security access information as new generation security access information when the security terminal of the storage device is activated.

26. The method of claim 25, further comprising the steps of:
determining whether the security area is activated by comparing the stored security access information received from the security terminal with the security access information stored in the storage device; and,
updating the security access information stored in the storage device with new generation security access information received from the security terminal when the security area is activated.

27. The method of claim 26, wherein the storage device further comprises an encryption key generation module for encrypting the security access information received from the security terminal through the user identification information, the terminal identification information, which is unique information of the security terminal, or the unique information of the storage device, and generating a data encryption key.

28. The method of claim 27, wherein a control unit encrypts and stores the data stored in the security area through the data encryption key, and decodes the data stored in the security area through the data encryption key and reads the data.

29. The method of claim 21, wherein the security access information is file system information defining a data storage, a search, and an access scheme for the security area; and further comprising the step of:
when the security access information is changed by using the security area, transmitting the changed security access information to the security terminal.

30. The method of claim 29, wherein a control unit generates file system information for the data set to an access authority and stores the file system information in the file system information for the general area when the access authority is stored in the security area.

31. The method of claim 30, wherein the file system information for the data to which the access authority is set includes setting information about the access authority, and the access authority is an allowance for one of reading, copying, changing, deleting, and outputting data.

32. The method of claim 22, wherein step (a) is performed by identifying a user's fingerprint or iris.

33. The method of claim 22, wherein step (a) is performed by receiving an authentication number or an authentication pattern from a user.
